(19) United States
(12) Patent Application Publication
(10) Pub. No.: US 2010/0304595 A1
(43) Pub. Date: Dec. 2, 2010

(54) BURN-IN SOCKET WITH INTENSIFIED SOCKET BODY

(75) Inventor: QUAN WANG, Shenzhen (CN)

Correspondence Address: WEI TE CHUNG;FOXCONN INTERNATIONAL, INC., 1650 MEMOREX DRIVE, SANTA CLARA, CA, 95050, US

(73) Assignee: HON HAI PRECISION INDUSTRY CO., LTD., Tu-Cheng (TW)

(21) Appl. No.: 12/791,892

(22) Filed: Jun. 2, 2010

(30) Foreign Application Priority Data
Jun. 2, 2009 (CN) 200920303896.5

(51) Int. Cl. H01R 13/62

(52) U.S. Cl. 439/331

(57) ABSTRACT

A burn-in socket for electrically connecting IC package to a printed circuit board, comprises a base, a sliding plate mounted to the base, and a plurality of contacts retained to the base and the sliding plate. The base has a plurality of protruding portions on a top surface thereof, the sliding plate is formed with a plurality of projecting portions on a bottom surface thereof, the protruding portions of the base abut against the bottom surface of the sliding plate, and the projecting portions of the sliding plate abut against the top surface of the base, so that the base and the sliding plate of the burin-in socket have an intensity.

### BACKGROUND OF THE INVENTION

1. Field of the Invention

The present invention relates to a burn-in socket, and more particularly to a burn-in socket mounted on a printed circuit board (PCB) for testing an IC package. The burn-in socket has socket body including a base and a sliding plate assembled to the base, and the sliding plate closely abuts against the base by a plurality of protruding portions disposed between the sliding plate and the base.

2. Description of Prior Art

Central Processing Unit (CPU) and other electrical package, generally referred to as IC package, are undergone a test simulating its real working environment so as to make sure its functions from all intended ranges.

A conventional burn-in socket typically comprises a base, a plurality of contacts disposed on the base, latches, a sliding plate for driving the contacts, and an actuator for actuating the latches and the sliding plate. The contact each has a pair of arms inserted into the sliding plate, and one is stationary, the other is moveable.

The sliding plate is assembled within the base and abuts against the base at a peripheral thereof, however, a gap is defined between the center part of the sliding plate and the base. When a plurality of contacts are assembled into the base and the sliding plate, may cause the sliding plate distorted and bowed, and make the center part of the sliding plate sink and the four sides rise up, that causes a head portion of the contacting arm of the contact assembled in the center part of the sliding plate excessively exposed from a top surface of the sliding plate, while other contacting arms assembled in the peripheral of the sliding plate are hidden in holes of the sliding plate. Thus, the contacts can not reliably contact with the IC package.

Thus, there is a need to provide an improved burn-in socket to overcome the above-mentioned problems.

### SUMMARY OF THE INVENTION

An object of the present invention is to provide a burin-in socket, which can prevent a sliding plate thereof from distorting.

In order to achieve the object set forth, a burn-in socket made in accordance with the present invention comprises a base, a sliding plate mounted to the base, and a plurality of contacts retained in the base and the sliding plate. The base has a plurality of protruding portions on a top surface thereof, the sliding plate is formed with a plurality of projecting portions on a bottom surface thereof, the protruding portions of the base abut against the bottom surface of the sliding plate, and the projecting portions of the sliding plate abut against the top surface of the base.

### BRIEF DESCRIPTION OF THE DRAWINGS

Other objects, advantages and novel features of the present invention will become more apparent from the following detailed description when taken in conjunction with the accompanying drawings, in which:

FIG. 1 is an assembled, perspective view of a burn-in socket in accordance with a preferred embodiment of the present invention;

FIG. 2 is an exploded, perspective view of the burn-in socket shown in FIG. 1;

FIG. 3 is a perspective view of a base of the burn-in socket shown in FIG. 2;

FIG. 4 is a perspective view of a sliding plate of the burn-in socket;

FIG. 5 is a cross-section view taken along line 5-5 of FIG. 1; and

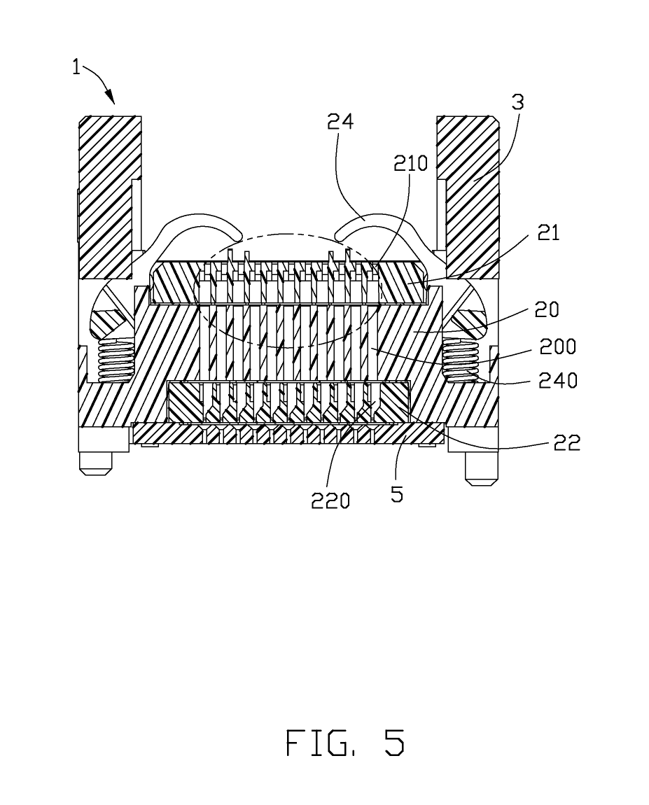

FIG. 6 is an enlarged view, showing a part of FIG. 5 in an elliptical line.

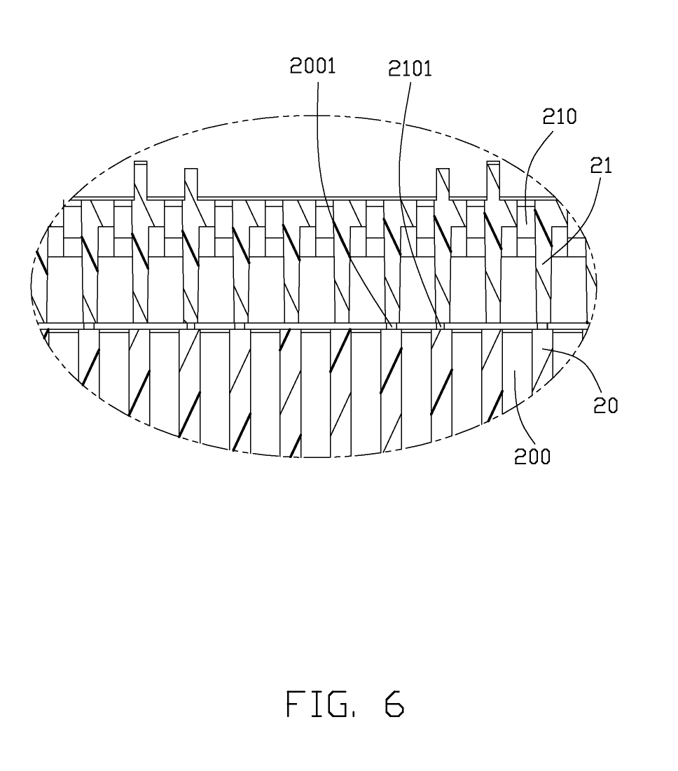

### DESCRIPTION OF PREFERRED EMBODIMENT

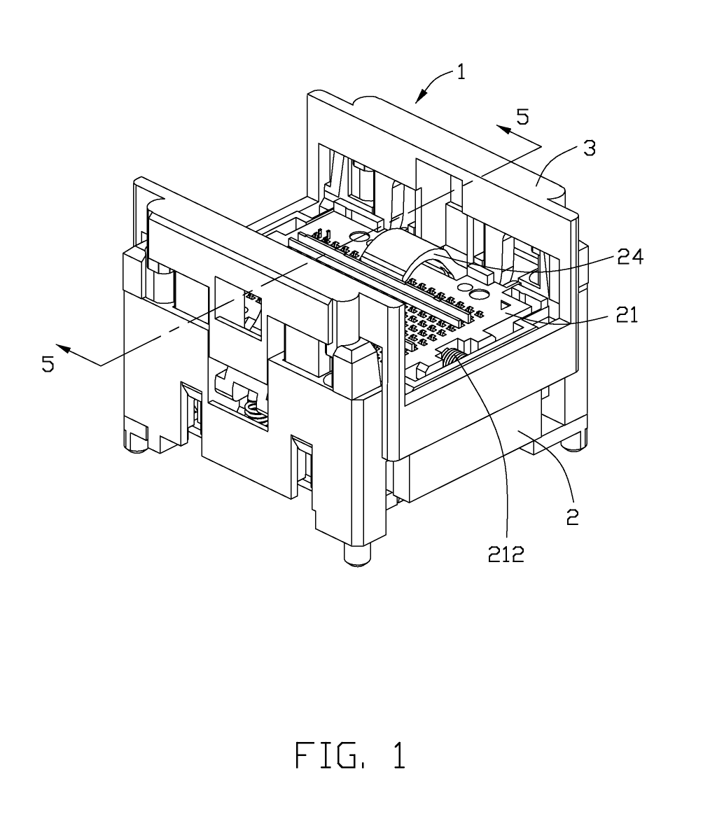

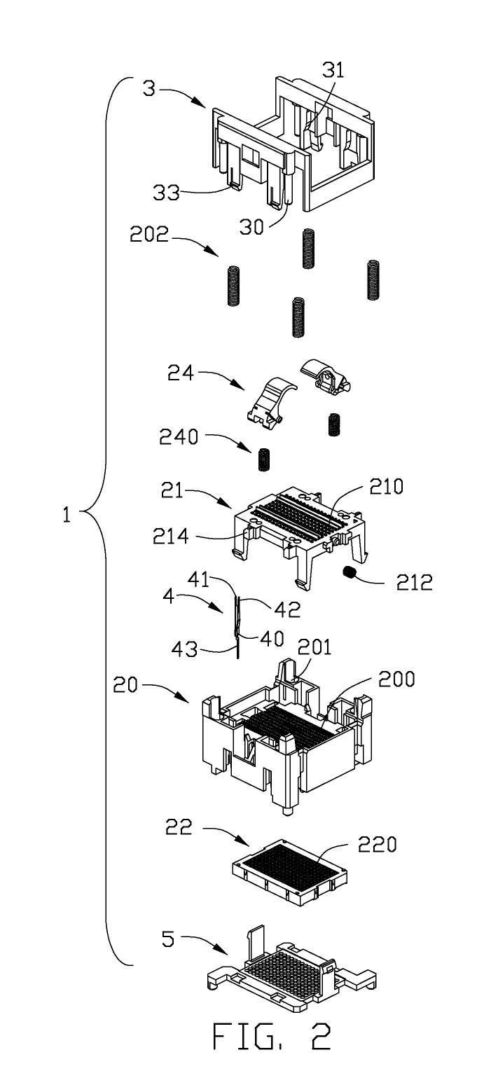

Referring to FIGS. 1-2, a burn-in socket 1 in accordance with a preferred embodiment of the present invention is generally mounted to a printed circuit board (not shown) to receive and test an IC package (not shown). The burn-in socket 1 includes a socket body 2, an actuator 3 movably mounted upon the socket body 2, a plurality of contacts 4 mounted to the socket body 2, and a latching board 5 latching to a bottom side of the socket body 2. The IC package (not shown) is put into the socket body 2 to be tested.

Referring to FIGS. 2-4, the socket body 2 includes a base 20, a sliding plate 21 disposed on the base 20 from a top side, a bottom plate 22 attached to bottom side of the base 20 and a pair of locking elements 24 to jointly lock the loaded IC package on the sliding plate 21. The base 20, the sliding plate 21 and the bottom plate 22, define a plurality of passageways 200, 210, 220, respectively. The base 20 has a recess 201 at each corner thereof for receiving a spring 202 therein.

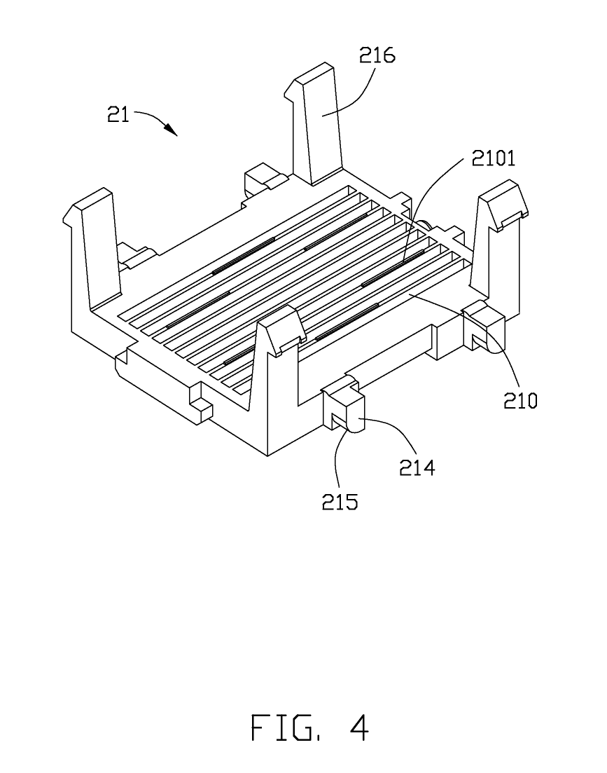

Referring to FIGS. 2 and 4, the sliding plate 21 is assembled in the base 20 and slides transversally by the actuation of the actuator 3. The sliding plate 21 has a bearing section 214 which forms a curved guiding surface 215 for mating with the actuator 3. A plurality of latches 216 project from the sliding plate 21 for securing the sliding plate 21 on the socket body 2. A spring 212 is incorporated with one end thereof abutting against the sliding plate 21 and the other end abutting against the base 20, thereby driving the sliding plate 21 back to its original position after the transversal movement.

Referring to FIG. 2, the contact 4 includes a middle base portion 40, a pair of testing arms respectively extending upwardly from the base portion 40, and a tail portion 43 extending downwardly from the base portion 40. The pair of testing arms includes a stationary arm 41 with a linear configuration and a moving arm 42 movable relative to the stationary arm 41. The top ends of the testing arms 41, 42 are formed with tip portions so as to jointly hold one solder ball (no shown) of the IC package. When the contact is assembled in the socket body 2, the base portion 40 is retained in the passageways 200 of the base 20, and the tip portions extend out of the passageways 210 of the sliding plate 21, while the tail portion 43 extends downwardly and out of the passageways 220 of the bottom plate 22.

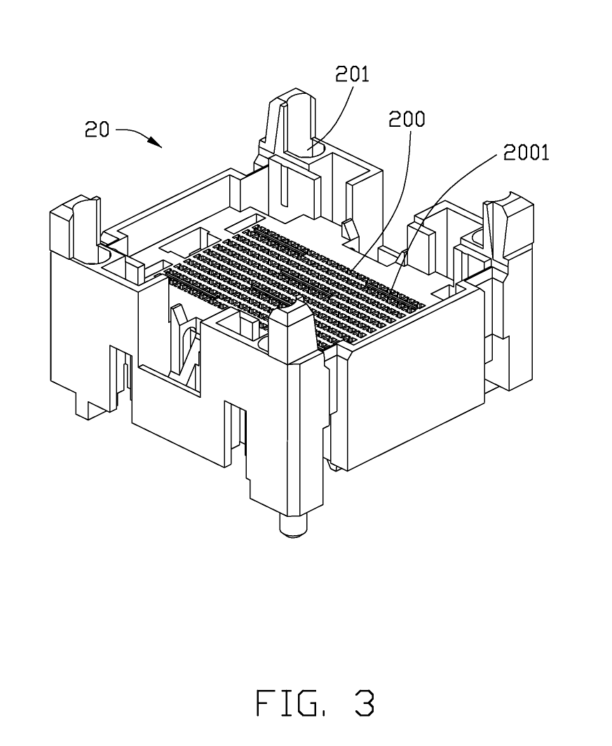

Particularly referring to FIG. 3 and FIG. 4, the base 20 is formed with a plurality of protruding portions 2001 on a top surface thereof, the protruding portion 2001 substantially has a strip shape and is disposed between two adjacent rows the passageways 200 of the base 20. The protruding portions 2001 distribute on a center part and a peripheral of the base 20. The sliding plate 21 further has a plurality of projecting portions 2101 on a bottom surface thereof, each projecting portion substantially has in a strip shape and is disposed between two adjacent rows of the passageways 210 of the sliding plate 21. The projecting portions 2101 substantially and equably distribute on the bottom surface of the base 20, but does not aligned with the protruding portions 2001 of the sliding plate in the top-to-bottom direction.

When the sliding plate 21 is assembled on the base 20, the protruding portions 2101 of the sliding plate 21 abut against the top surface of the base 20, and the projecting portions 2001 of the base 20 abut against the bottom surface of the sliding plate 21, the protruding portions 2101 and corresponding projecting portions 2001 are located in a beeline. By such arrangement, the projecting portions 2001 and the protruding portion 2101 are filled in a distance between the top surface of the base 20 and the sliding plate 21, the sliding plate 21 is reliably supported, and a configuration of the socket body 2 is reinforced, thus the sliding plate 21 will not easily bow when assembling the contacts 4.

The actuator 3 has four posts 30 extending downwardly engaging with the recesses 201 of the base 20, an actuating portion 31 extending downwardly for driving the bearing section 214 of the sliding plate 21 and two pair of latches 33 for positioning the actuator 3 on the base 20.

When using, the actuator 3 is forced to a lower position, where the moving and stationary arms 41, 42 are spaced from each other, in this situation, the IC package is easily placed into the socket body 2 or to be taken out of the socket body 2. When the actuator 3 returns to an original position, the moving and stationary arms 41, 42 move closer to each other and jointly hold the solder ball (not shown) of the IC package. Besides, a spring 202 is provided between the actuator 3 and the socket body 2 so as to reset the actuator 3 after its downward movement.

Although the present invention has been described with reference to particular embodiments, it is not to be construed as being limited thereto. Various alterations and modifications can be made to the embodiments without in any way departing from the scope or spirit of the present invention as defined in the appended claims.

What is claimed is:

1. A burn-in socket comprising:
a base having a plurality of protruding portions on a top surface thereof;
a sliding plate mounted to the base, and formed with a plurality of projecting portions on a bottom surface thereof;
a plurality of contacts retained to the base and the sliding plate; wherein
the protruding portions of the base abut against the bottom surface of the sliding plate, and the projecting portions of the sliding plate abut against the top surface of the base.

2. The burn-in socket as claimed in claim 1, wherein the protruding portions are located between two rows passageways defined on the base.

3. The burn-in socket as claimed in claim 2, wherein the protruding portion substantially has a strip shape, the protruding portions distribute on a center part and a peripheral of the base, respectively.

4. The burn-in socket as claimed in claim 3, wherein the projecting portion substantially has a strip shape, the projecting portion distribute on a peripheral of the sliding plate.

5. The burn-in socket as claimed in claim 3, wherein protruding portions and corresponding projecting portions extend along a same beeline.

6. The burn-in socket as claimed in claim 4, further comprising an actuator, the actuator has two pair of latches for positioning the actuator on the base and an actuating portion extending downwardly for driving the sliding plate.

7. The burn-in socket as claimed in claim 1, further comprising a pair of locking elements jointly lock the IC package loaded on the sliding plate.

8. A burn-in socket comprising:
a base having a plurality of passageways and defining a top surface;
a sliding plate mounted on the base and having a plurality of passageways, the sliding plate defining a bottom surface facing to the top surface of the base;
a plurality of contacts extending through the passageways of the sliding plate and the base; and
a plurality of supporting portions disposed between the sliding plate and the base to support the sliding plate.

9. The burn-in socket as claimed in claim 8, wherein the supporting portions are formed on the center part and the peripheral of the bottom surface of the sliding plate, and each substantially has a strip shape.

10. The burn-in socket as claimed in claim 9, wherein the supporting portions are located between two rows the passageways of the sliding plate.

11. The burn-in socket as claimed in claim 8, wherein the supporting portions are formed on the top surface of the base, and each substantially has a strip shape.

12. The burn-in socket as claimed in claim 11, wherein the supporting portions are located between two rows the passageways of the base.

13. The burn-in socket as claimed in claim 8, wherein the supporting portion includes a plurality of protruding portions formed on the bottom surface of the sliding plate, and a plurality of projecting portions formed on the top surface of the sliding plate, the protruding portions abut against the base, and the projecting portions abut against the sliding plate.

14. The burn-in socket as claimed in claim 13, wherein a center part and a peripheral of the sliding plate is reliably supported by the supporting portions.

15. A burn-in socket comprising:
an insulative base defining a plurality of lower passageways, respectively;
an insulative sliding plate positioned upon the base and being back and forth moveable in a first direction, said sliding plate defining a plurality of upper passageways, respectively, said upper passageways being essentially aligned with the corresponding lower passageways, respectively;
a plurality of contacts each having a main body disposed in the corresponding lower passageway, and an upper end portion disposed in the corresponding upper passageway; and
a plurality of protrusions unitarily located between the base and the sliding plate; wherein
said protrusions are formed with at least one of said base and said sliding plate and extends toward and reach the other under condition that said protrusions are horizontally offset from the corresponding lower passageways and the upper passageways.

16. The burn-in socket as claimed in claim 15, wherein said protrusions are categorized with:
a first set of protrusions formed on an upper surface of the base to abut against a bottom surface of the sliding plate; and
a second set of protrusion formed on said bottom surface of the sliding plate to abut against said upper surface of the base; wherein
the first set of protrusions and the second set of protrusions are essentially of a same height while being properly horizontally offset from each other for no interference therebetween during relative movement of the sliding plate with regard to the base.
